(19) United States
(12) Patent Application Publication
(10) Pub. No.: US 2025/0277930 A1
(43) Pub. Date: Sep. 4, 2025

(54) METHODS OF INCREASING HIGHER-ORDER MODE SUPPRESSION IN LARGE-MODE AREA RING FIBERS AND SYSTEMS THEREOF

(71) Applicant: OFS Fitel LLC, Norcross, GA (US)

(72) Inventors: Poul Kristensen, Valby (DK); Jeffrey W Nicholson, Warren, NJ (US)

(73) Assignee: OFS Fitel LLC, Norcross, GA (US)

(21) Appl. No.: 18/285,863

(22) PCT Filed: Apr. 6, 2022
(86) PCT No.: PCT/US2022/023602

§ 371 Date: Oct. 6, 2023

Related U.S. Application Data
(60) Provisional application No. 63/171,441, filed on Apr. 6, 2021.

(51) Int. Cl. G02B 6/02

(52) U.S. Cl. CPC G02B 6/02019

(57) ABSTRACT

Embodiments of the present disclosure generally relate to methods of increasing higher-order mode suppression in large-mode area ring fibers. This approach may raise the transverse mode instabilities (TMI) threshold and allow further mode-field diameter (MFD) scaling for higher power. Disclosed herein is a core having a set of core properties, a cladding ring around the core, wherein the optical fiber has fundamental mode effective MFD between 14 microns and 40 microns; and wherein the optical fiber exhibits a higher-order mode loss of L_{HOM}.

### CROSS-REFERENCE TO RELATED APPLICATIONS

The present application claims priority to U.S. Provisional Patent Application Ser. No. 63/171,441 entitled “Increasing higher-order mode suppression in large-mode area ring fibers,” filed Apr. 6, 2021, the disclosure of which is incorporated herein by reference in its entirety.

### BACKGROUND

Embodiments of the present disclosure are generally related to higher-order mode suppression. In general, a fiber laser may be a laser in which the active gain medium is an optical fiber doped with rare-earth elements such as erbium, ytterbium, neodymium, dysprosium, praseodymium, thulium, holmium, and/or the like. Fiber lasers are related to doped fiber amplifiers, which provide light amplification without lasing. Advances in fiber lasers have created opportunities for use in various applications and implementations. Fiber lasers are used extensively in industrial laser-processing applications that require both high power and high beam quality. For example, laser cutting and laser welding of metals and metal alloys, or the like. A core is typically energized with pump radiation provided by a plurality of diode lasers. Diode lasers efficiently convert electrical power into optical power that can be directed into a gain fiber. In a “cladding-pumped” arrangement, the pump radiation is guided along the gain fiber in a pump cladding that jackets the core. An outer cladding jackets the pump cladding.

Certain applications of fiber lasers require specific power levels. To achieve required power levels needed for certain fiber laser applications, a number of lasers can be combined for increased power. Fiber lasers can be combined using spectral or coherent combining. Scaling the output power of fiber lasers is limited by nonlinearities, such as stimulated Brillouin scattering (SBS), stimulated Raman scattering (SRS), self-phase modulation (SPM), or the like. For fiber lasers designed for narrow-linewidth operation, in particular, SBS is the dominant nonlinearity. In contrast, fiber lasers designed for commercial applications where the linewidth does not need to be narrow are often limited by SRS.

One method of reducing nonlinearities and increasing output power is increasing the effective area of the fundamental mode of the fiber. As the effective area of the fiber increases, it becomes increasingly difficult to maintain single-mode operation of the fiber, however. At a certain point, as effective area increases and higher-order mode (HOM) losses decrease, transverse mode instabilities (TMI) become a limiting factor in increasing output power rather than nonlinearities.

TMI results when a thermally induced refractive index grating generated by quantum defect heating couples the fundamental mode to the higher-order mode. Generally, the linearly polarized (LP) LP11 mode is the dominant HOM of concern. As the modes couple together, the output of the laser randomly fluctuates with kHz frequency between the fundamental mode and HOM, causing significant noise and degrading beam quality. The TMI threshold is typically increased by increasing the bend loss of the HOMs, but this also increases the loss of the fundamental mode signal and reduces optical efficiency, limiting the achievable HOM loss.

Therefore, there is a natural trade-off in designing fibers for high-power fiber lasers. Increasing the effective area increases the threshold of nonlinearities but decreases the threshold of TMI. Also, increasing the TMI threshold by increasing HOM bend loss reduces optical efficiency. Various simple step-index profiles have been optimized to balance these limitations. The effective mode-field diameter (MFD) of the fundamental mode (defined as 2*(effective area/pi)\hat{ }0.5) of these fibers is typically less than 20 microns, the LP01 bend-induced loss is kept less than 2 dB/m, and the higher-order mode loss >200 dB/m. These designs are extremely sensitive, however, resulting in low yield in fiber fabrication. Further scaling of the output power beyond what is currently achievable with the existing designs is not available. A need exists for a new approach to increase the higher-order mode loss of these fibers.

### SUMMARY

Embodiments of the present disclosure generally relate to methods of increasing higher-order mode suppression in large-mode area fibers with a ring in the cladding. This approach may raise the transverse mode instabilities (TMI) threshold and allow further mode-field diameter (MFD) scaling for higher power. Additionally, this approach may also increase fiber manufacturing yield by broadening the range of index profiles that can attain desired nonlinear and TMI thresholds.

Embodiments of the present disclosure may also include an optical fiber that may include a core having a set of core properties; a cladding ring around the core; wherein the optical fiber has fundamental mode effective mode-field diameter (MFD) between 14 microns and 40 microns; and wherein the optical fiber exhibits a higher-order mode loss of L_{HOM}. In some implementations, the optical fiber may comprise a fundamental mode effective MFD between 14 microns and 37 microns.

Embodiments of the present disclosure may also include an optical fiber, comprising: a core having a set of core properties; a cladding ring around the core, the cladding ring starting between 3 microns and 15 microns from the edge of the core; wherein the optical fiber has fundamental mode effective mode-field diameter (MFD) between 14 microns and 40 microns; wherein the optical fiber exhibits a higher-order mode loss of L_{HOM} and a higher-order mode power overlap of P_{HOM}.

Embodiments of the present disclosure may also include a method of increasing higher-order mode suppression in large mode area ring fibers, comprising: providing an optical fiber comprising: a core having a delta n less than 2e-3; a cladding ring around the core, the cladding ring starting between 3 microns and 15 microns from the edge of the core; wherein the optical fiber has fundamental mode effective mode-field diameter (MFD) between 14 microns and 40 microns; wherein the optical fiber exhibits a higher-order mode loss of L_{HOM} and a higher-order mode power overlap of P_{HOM}; and propagating light through the optical fiber.

### BRIEF DESCRIPTION OF THE DRAWINGS

So the manner in which the above-recited features of the present disclosure can be understood in detail, a more particular description of embodiments of the present disclosure may be had by reference to the appended drawings. It is to be noted, however, the appended drawings illustrate only exemplary embodiments encompassed within the scope of the present disclosure and are not to be considered limiting, for the present disclosure may admit to other equally effective embodiments, wherein:

FIG. 1A is a chart illustrating a design for a Yb-doped fiber;

FIG. 1B is a chart illustrating an exemplary design for Yb-doped fiber in accordance with embodiments of the present disclosure;

FIG. 2A is a chart illustrating the relationship between mode loss and bend diameter in accordance with embodiments of the present disclosure;

FIG. 2B is a chart illustrating a relationship between mode loss and bend diameter for a fiber with a ring feature in accordance with embodiments of the present disclosure;

FIG. 3A is a chart illustrating mode power overlap with the cores of the fundamental mode and higher-order modes (HOMs) without a ring, in accordance with embodiments of the present disclosure;

FIG. 3B is a chart illustrating a mode power overlap with the cores of the fundamental mode and HOMs with a ring, in accordance with embodiments of the present disclosure;

FIG. 4 is a plot illustrating a profile of a ring fiber in accordance with embodiments of the present disclosure;

FIG. 5 is a chart illustrating a relationship between LP11 loss at spiral end and MFD in accordance with embodiments of the present disclosure; and

FIG. 6 is a flow chart illustrating a method of increasing higher-order mode suppression in large-mode area ring fibers in accordance with embodiments of the present disclosure.

The headings used herein are for organizational purposes only and are not meant to be used to limit the scope of the description or the claims. As used throughout this application, the word “may” is used in a permissive sense (i.e., meaning having the potential to), rather than the mandatory sense (i.e., meaning must). Similarly, the words “include”, “including”, and “includes” mean including but not limited to. To facilitate understanding, like reference numerals have been used, where possible, to designate like elements common to the figures.

### DETAILED DESCRIPTION

Embodiments of the present disclosure generally relate to methods of increasing higher-order mode suppression in large-mode area ring fibers. This approach may raise the transverse mode instabilities (TMI) threshold and allow further mode-field diameter (MFD) scaling for higher power. Additionally, this approach may also increase manufacturing yield by broadening the range of index profiles that can attain desired nonlinear and TMI thresholds.

The exemplary embodiments described herein relate to a cladding feature added to a design of high-power fiber laser fibers. According to the embodiments described herein, this cladding feature may significantly increase the higher-order mode loss while decreasing higher-order mode overlap with the rare-earth doped fiber core for fibers with mode-field diameters in the 14 micron to 40 micron range, allowing for higher power operation. In some implementations, the optical fiber may comprise an MFD between 14 microns and 37 microns.

TMI generally prevents power scaling in fiber lasers. TMI includes power transfer between fundamental mode and LP11 higher order modes (HOM) facilitated by a thermally induced index grating. Increasing mode-field diameter (MFD) may result in a higher nonlinear threshold, a lower HOM loss, and an associated lower TMI threshold. A nonlinear threshold may include a stimulated Brillouin scattering (SBS), Raman, four-wave-mixing (FWM) threshold, or the like. Four-wave mixing (FWM) may be an intermodulation phenomenon in nonlinear optics, whereby interactions between two or three wavelengths produce two or one new wavelengths. TMI impacts both commercial fiber lasers and directed energy fiber laser programs. One approach to suppressing TMI is to increase HOM loss. Increasing HOM loss becomes more difficult for large mode-field diameters. Increasing HOM loss while maintaining MFD allows for increased manufacturing yield for current operating power levels, and increased efficiency by operating at lower LP01 loss while maintaining high LP11 loss. It also allows for scaling to a larger effective area, reducing nonlinearities, and increasing operating power levels. Increasing gain dopant concentration may reduce nonlinearities by reducing fiber length, but this may be detrimental due to increase photodarkening, which reduces the TMI threshold.

In accordance with exemplary embodiments, a cladding ring, or the like, may be added to an index profile. Adding a cladding ring may increase HOM bend-loss through resonances, or the like. A symmetry of LP11 mode with respect to bending may include parallel symmetry, orthogonal symmetry. With parallel symmetry, typically there is higher bend loss. With orthogonal symmetry, typically there is lower bend loss. In some implementations, with a resonance, parallel symmetry LP11 mode has a lower loss than orthogonal symmetry at some bend diameters. In some implementations, quantum-defect induced heating generated during operation in an amplifier may maximize the benefits of a ring because the refractive index profile of the fiber is altered through the thermo-optic coefficient.

In some implementations, for example, in a 19-micron MFD Yb-doped fiber and a 16-micron MFD fiber with graded index core, keeping the core the same and adding a ring increases HOM bend loss over broad bend diameter range. Adding a ring may substantially reduce HOM mode overlap with the core without impacting fundamental mode overlap. In some embodiments, a ring design for a given index profile may be optimized and then applied to other measured fiber index profiles. The ring design may be optimized for a single profile, but it may also confer an increase in HOM bend-loss over a wide range of fiber designs and MFDs. Ring design may be robust to core changes.

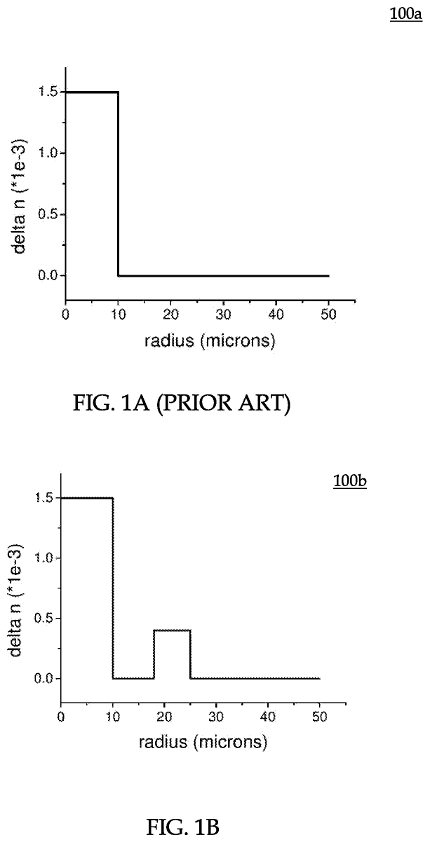

FIG. 1A is a chart illustrating a design 100a for a Yb-doped fiber. FIG. 1B is a chart illustrating an exemplary design 100b for Yb-doped fiber in accordance with embodiments of the present disclosure. In some embodiments of the present disclosure, a solution to increasing the loss of the HOMs without increasing the loss of the fundamental mode is to add an extra structure into the cladding near the core. This structure may be referred to as a ring. FIG. 1A illustrates a design for a high-power Yb-doped fiber, whereas FIG. 1B shows an additional ring-structure for HOM suppression. Exemplary design parameters illustrated in FIG. 1B are starting radius, delta n, width, or the like. It may be optimized to interact predominantly with the higher-order mode, while the index of the ring is kept low enough to avoid significant perturbations to the fundamental mode. Furthermore, one or more rings may be used.

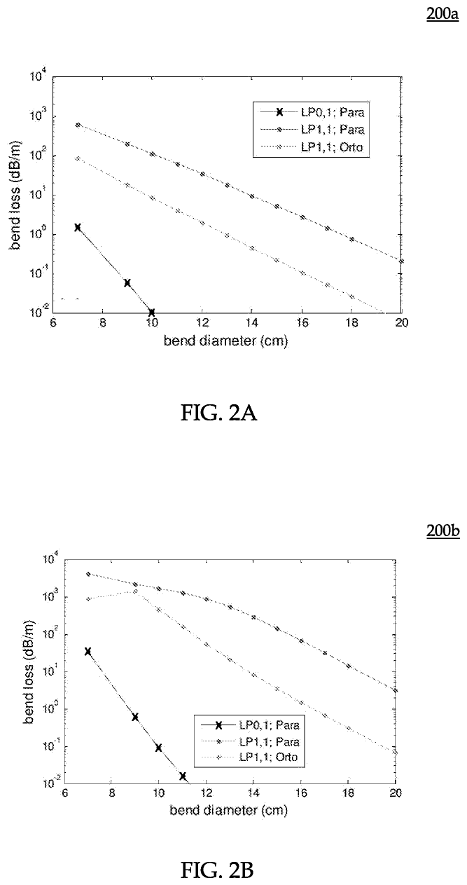

FIG. 2A is a chart 200a illustrating the relationship between mode loss and bend diameter without a ring feature in accordance with embodiments of the present disclosure. FIG. 2B is a chart 200b illustrating a relationship between mode loss and bend diameter for a fiber with a ring feature in accordance with embodiments of the present disclosure. The curves on the chart show a fundamental mode loss as a function of bend diameter and the parallel and orthogonal symmetry LP11 modes. As shown in the FIG. 2B, adding a ring increases HOM loss. The LP01 loss also increases and the ratio of LP11/LP01 loss increases. In some implementations, a higher LP01 bend loss can be accommodated by moving an operating point to larger bend diameters. Core and ring designs may also provide a desirable bend radius.

Table 1 below shows calculated LP11 loss at the bend diameter where LP01 loss=1 dB/m. When adding the ring, the bend diameter where LP01=1 dB/m loss increases from 7.7 cm to 9 cm. However, at that diameter, the LP11 loss increases from 59 dB/m to 1380 dB/m with the addition of the ring. The mode-field diameter of the fiber is substantially unchanged with the addition of the ring.

TABLE 1
Mode losses in the fiber with and without ring.

| | | | | Bend diameter | | |
|---|---|---|---|---|---|---|
| | | | | for | | Mode- |
| | LP01 | LP11 | | LP01 loss = | | field |
| | loss | loss | | 1 dB/m | | diameter |
| Conventional | 1 dB/m | 59 | dB/m | 7.7 | cm | 19.4 microns |
| fiber | | | | | | |
| Ring | 1 dB/m | 1380 | dB/m | 9 | cm | 19.5 microns |
| fiber | | | | | | |

The ring may increase the calculated HOM loss of the fiber and leads to increased TMI thresholds. Bend loss may be calculated by a mode solver based on the refractive index of the fiber. In low index coated fibers, high bend loss of the core implies high coupling to cladding modes, but the power coupled to those cladding modes remains guided by the fiber. The calculated loss is a proxy for how much the HOM samples the glass-coating interface.

Because of the issue of bend-loss in low-index coated fibers, it is useful to also consider how much the HOM overlaps with the gain-doped region of the fiber. The ring may cause the LP11 to extend its energy into the cladding. As such, the overlap of the HOM with the core of the fiber decreases when the ring is added to the index profile. This is another benefit to fiber lasers as the lower the overlap is with the gain-doped region, the less gain the HOM will have, further increasing the TMI threshold. In many cases, the gain dopant resides only within the full extent of the core. For instances in which the gain dopant is confined to a portion of the core or extends beyond the core, the mode power overlap should consider the gain-doped region of the fiber.

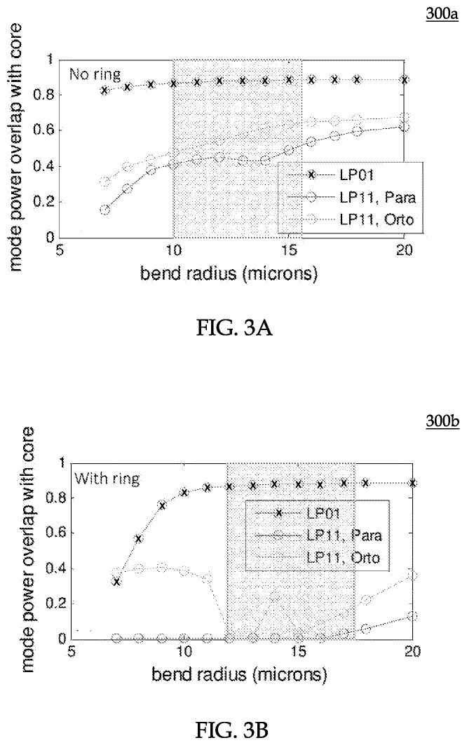

FIG. 3A is a chart 300a illustrating mode power overlap with the cores of the fundamental mode and higher-order modes (HOMs) without a ring. FIG. 3B is a chart 300b illustrating a mode power overlap with the cores of the fundamental mode and HOMs with a ring, in accordance with embodiments of the present disclosure. FIG. 3A and FIG. 3B show the calculated mode overlap with the core of the fundamental mode and HOMs with a ring and without a ring for a particular index profile design. A shaded area of the chart illustrates that the operating diameters typically used when a 10 m long Yb-doped fiber is laid in a spiral wind. The fundamental mode overlap with the core is un-changed in the expected operating diameter range, but the higher-order mode overlap with the core is dramatically decreased. The operating diameter may shift to slightly larger diameters with the addition of the ring, which can be compensated for at the design phase for the core.

In some implementations, the advantages provided by the ring are robust to details of the ring index profile. Although the interaction between the HOM and the ring is based on resonance and maximized for a specific ring design in terms of inner ring diameter, ring width, and delta n, significant increases in loss and decreases in core overlap are maintained over a wide range of designs. This makes the ring design robust and may increase fiber yield. There may be an area in the design space that optimizes for both high LP11 loss and low mode overlap with the core.

In some embodiments of the present disclosure, a ring works because the fibers exhibit low NA, leading to relatively weak core confinement and high loss for the LP11 modes, even without a ring. Adding the ring to such a sensitive design promotes leakage of the HOM into the cladding.

FIG. 1A, 1B, 2A, 2B, 3A, and 3B illustrate data related to fibers with step-index like cores. The ring may work equally well with graded-index cores such as fibers used in commercial fiber-lasers, or the like. The ring may work equally well with cores that deviate from an idealized step index fiber and show peaks or dips in the profile.

The calculations described herein may be performed on the index profile of the fiber as measured, for example, at room temperature. When operated in an amplifier, heating caused by a quantum defect between the pump and signal can cause a substantial change in index profile due to the thermo-optic effect. Taking this effect into account at the design stage may further improve a fiber's performance in a high-power amplifier.

The discussion above considers the bend diameter of fiber wound in a coil, with bend diameter varying along the fiber length. In some implementations, this is advantageous because TMI may be most severe at the signal input end of the fiber, and HOM bend loss can be higher even at the expense of locally higher LP01 loss. In some implementations, it is desirable to manage the HOM bend loss or core overlap averaged along the gain fiber length. In some implementations, the path-average properties-based optical power may be used. This may be relevant when applied to passive fibers that do not produce gain and must avoid nonlinear effects, or the like.

While a coil configuration is described herein, in some instances, the fiber may be wound with essentially uniform bend diameter, such as held in a ring or wound on a cylinder. This may be enabled by a feature of a ring-based design wherein HOM loss and the LP11/LP01 loss ratio has less variation with bend diameter than a ringless design. The relative insensitivity of bend loss with bend diameter for low NA, large for fiber designs can be very advantageous for both high performance and improved packageability.

The properties described herein may be important near the thresholds for detrimental effects like nonlinearity and TMI, which occur when the device is operating at high power and therefore under high thermal load. Because the refractive index of the fiber varies with temperature, it may be important to compensate the fiber design to produce desirable properties when operated in a target operating temperature range.

Some fibers may have ring-like structures as well as trenches with refractive index less than the remainder of the pump cladding. The combination of ring and trench structures may be used to further increase the HOM loss.

The exemplary embodiments of the present invention may include design parameters relevant to high-power fiber lasers. In the context of high-power fiber lasers for commercial and directed energy applications, these parameters may include, for example: a solid core with solid cladding fibers to distinguish between microstructured fiber approaches; an MFD greater than 14 microns; an MFD less than about 40 microns. In some embodiments, designs may comprise MFD at 25 microns with some advantages. Above 40 microns, a ring approach to HOM suppression may be more difficult.

In some embodiments of the present disclosure low delta n fibers may be used. As described herein, a ring may work because a fiber core design may be adjusted to a point where the LP11 bend loss is significant and may interact with the ring. For example, the core delta n may be limited to <2e-3, or the like. In some embodiments, a ring with delta n substantially less than the core may be used. As ring delta n approaches the core delta n, the fundamental mode may become lossy. In this example, a ring delta n may be limited to <70% of the core delta n. Another parameter may include a ring that starts at least 2 microns away from the edge of the core and no more than 15 microns away from the edge of the core, or the like. If the ring is too far away from the core, the design space narrows, and it becomes harder to achieve simultaneous high loss and low HOM core overlap. If the ring is too close to the core, it may become hard to fabricate. Another parameter may include high HOM loss, for example, LP11>300 dB/m.

In some implementations, a fiber design based on multi-dimensional optimization routine found ring-based designs with HOM loss that exceeds that of 19-micron fibers with MFD up to 23.5 microns. According to the exemplary embodiments described herein, a design algorithm determines designs at 25-micron MFD with HOM loss >200 dB/m. In some implementations, designs allow higher values of HOM loss at larger MFD, with >200 or even >300 dB/m for MFD exceeding 25 or even 30 micron.

The designs discussed here may show a single, rectangular-shaped ring. Although the appearance of the ring appears rectangular, the sides of the ring may acquire a slope during draw due to diffusion. Other ring shapes such as triangular or graded index may also offer benefits. There may also be benefits to using multiple rings in the cladding. Rings may be continuous with constant or azimuthally-varying inner and outer radii, or comprised of discrete segments.

In accordance with exemplary embodiments of the present disclosure, an optical fiber may be designed and produced. In some implementations, an optical fiber may include a core and a ring. The properties of the optical fiber may include: a core comprising a delta n<2e-3; a ring starting between 3 and 15 microns from the edge of the core, the ring comprising a delta n<0.7*delta n of the ring; wherein the fiber has a fundamental de effective MFD between 14 microns and 30 microns, the fiber has a fundamental mode loss <1 dB/m occurring at a bend diameter between 5 cm and 30 cm, and the fiber has a higher order mode loss >300 dB/m at a bend diameter where the fundamental mode loss=1 dB/m.

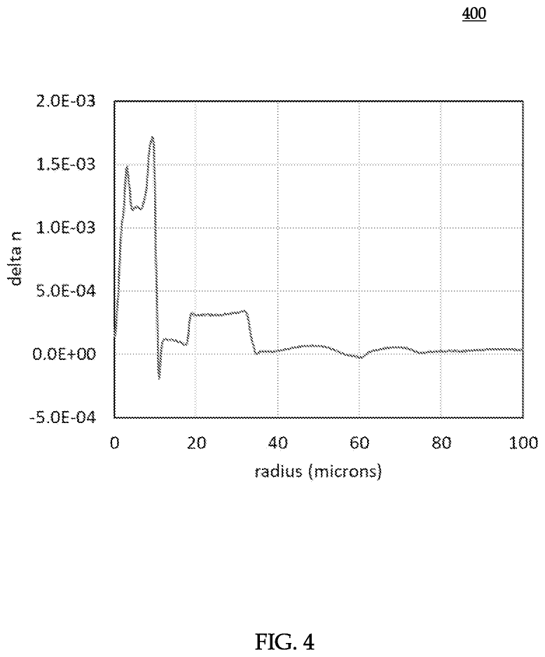

FIG. 4 is a plot 400 illustrating a profile of a ring fiber in accordance with embodiments of the present disclosure. The plot 400 displays a relationship of delta n and radius (microns) of a ring fiber in accordance with embodiments of the present disclosure. The fiber may comprise a cladding ring in accordance with embodiments of the present disclosure. A cladding ring may be added to increase a TMI threshold, or the like. In accordance with exemplary embodiments, a fabricated ring fiber may be used.

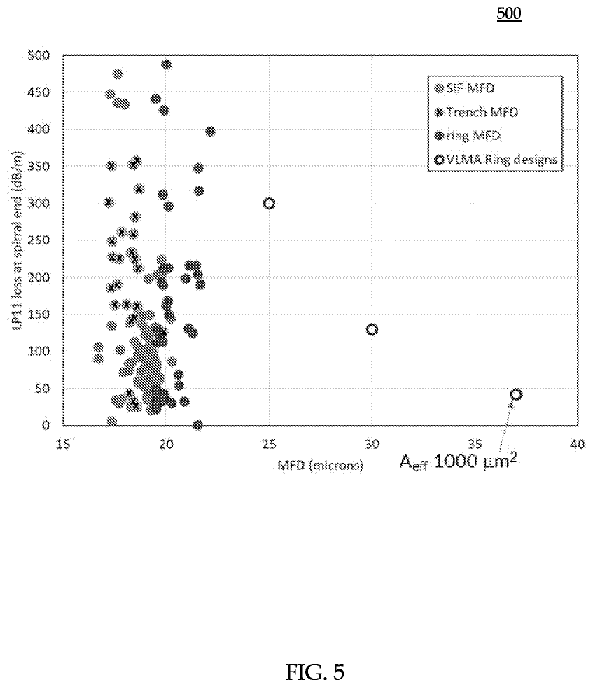

FIG. 5 is a chart 500 illustrating a relationship between LP11 loss at spiral end and MFD in accordance with embodiments of the present disclosure. In some implementations, designs for ring fibers for pulsed Yb fiber amplifiers are scalable to mode fields as large as 37 microns, or the like. The chart 500 shows a compilation of fabricated fibers in accordance with embodiments of the present disclosure, showing that at larger mode-field, the ring fibers achieve significantly higher HOM loss than a conventional step index design. For example, at 25-micron MFD, designs have higher HOM loss than 19-micron MFD, step-index fibers. At 37-micron MFD, designs have greater than 40 dB/m loss, which may be enough to support greater than 1 kW, TMI free signal power, or the like. As MFD is scaled, delta n may decrease, and operating diameter may increase. In some implementations, at 37-micron MFD, operating diameter may be approximately 30 cm, or the like.

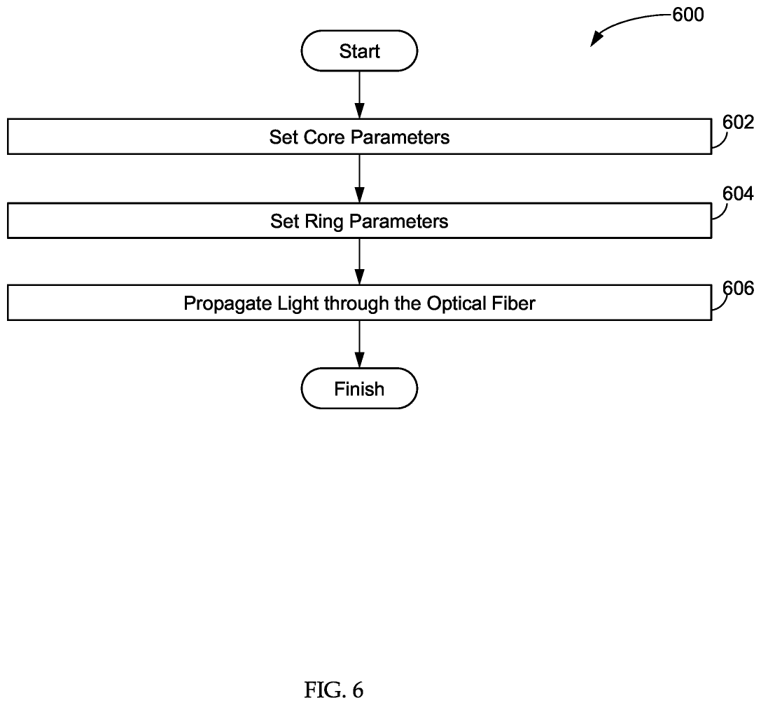

FIG. 6 is a flow chart illustrating a method 600 of increasing higher-order mode suppression in large-mode area ring fibers in accordance with embodiments of the present disclosure. The method 600 may begin at step 602, the core properties or parameters are set. Core properties may comprise, for example, a delta n<2e-3. The method may continue at step 604, where the ring parameters are set. The ring parameters may comprise, for example, the ring starting between 3 and 15 microns from the edge of the core, the ring having a delta n<0.7*delta n of the ring. Defining the core design in step 602 in terms of delta n and core radius may substantially define the MFD and operating bend diameter. In step 604, defining the ring design may determine the HOM loss and fine tune the operating diameter. The fiber parameters may comprise, for example: a fiber having a fundamental mode effective MFD between 14 microns and 30 microns; a fundamental mode loss <1 dB/m occurring at a bend diameter between 5 cm and 30 cm; and a higher order mode loss >300 dB/m at a bend diameter where the fundamental mode loss=1 dB/m. At step 606, light may be propagated through the fiber, or the like.

For the purpose of simplification and clarity of illustration, a general configuration scheme is illustrated in the accompanying drawings, and a detailed description for the features and the technology well-known in the art is omitted in order to prevent the discussion of exemplary embodiments of the present disclosure from being unnecessarily obscure. Additionally, components in the accompanying drawings are not necessarily drawn to scale. For example, sizes may be exaggerated in order to assist in the understanding of exemplary embodiments of the present disclosure.

It will be understood that exemplary embodiments of the present disclosure set forth herein may be operated in a sequence different from a sequence illustrated or described herein. In the case in which it is described herein that a method includes a series of steps, a sequence of these steps suggested herein is not necessarily a sequence in which these steps may be executed.

Terms used in the present disclosure are for explaining exemplary embodiments rather than limiting the present disclosure. In the present disclosure, a singular form includes a plural form unless explicitly described to the contrary. Components, steps, operations, and/or elements mentioned by terms “comprise” and/or “comprising” used in the disclosure do not exclude the existence or addition of one or more other components, steps, operations, and/or elements.

Hereinabove, the present disclosure has been described with reference to exemplary embodiments thereof. All exemplary embodiments and conditional illustrations disclosed in the present disclosure have been described to intend to assist in the understanding of the principle and the concept of the present disclosure by those skilled in the art to which the present disclosure pertains. Therefore, it will be understood by those skilled in the art to which the present disclosure pertains that the present disclosure may be implemented in modified forms without departing from the spirit and scope of the present disclosure. Although numerous embodiments having various features have been described herein, combinations of such various features in other combinations not discussed herein are contemplated within the scope of embodiments of the present disclosure.

What is claimed is:

1. An optical fiber, comprising:
a core having a set of core properties;
a cladding ring around the core;
wherein the optical fiber has fundamental mode effective mode-field diameter (MFD) between 14 microns and 40 microns; and
wherein the optical fiber exhibits a higher-order mode loss of L_{HOM}.

2. The optical fiber of claim 1, further comprising a second cladding ring around the core.

3. The optical fiber of claim 1, further comprising:
a second cladding ring around the core; and
a trench.

4. The optical fiber of claim 1, wherein L_{HOM} of the optical fiber is at least 1.5 times greater than an optical fiber having the set of core properties without the cladding ring.

5. The optical fiber of claim 1, wherein the optical fiber exhibits a higher-order mode power overlap of P_{HOM}.

6. The optical fiber of claim 1, wherein the P_{HOM} of the optical fiber is at least 30% less than an optical fiber having the set of core properties without the cladding ring.

7. The optical fiber of claim 1, wherein the set of core properties comprise:
a core having a delta n less than 2e-3.

8. The optical fiber of claim 1, wherein the ring starts between 3 microns and 15 microns from the edge of the core.

9. The optical fiber of claim 1, wherein the ring comprises a delta n<0.7×delta n of the ring.

10. The optical fiber of claim 1, wherein the fiber comprises a fundamental mode effective MFD between 14 microns and 37 microns.

11. The optical fiber of claim 1, wherein the fiber comprises a fundamental mode loss less than 1 dB/m occurring at a bend diameter between 5 cm and 30 cm.

12. The optical fiber of claim 1, wherein the fiber comprises a higher order mode loss greater than 300 dB/m at a bend diameter, wherein the fundamental mode loss is 1 dB/m.

13. An optical fiber, comprising:
a core having a set of core properties;
a cladding ring around the core, the cladding ring starting between 3 microns and 15 microns from the edge of the core;
wherein the optical fiber has fundamental mode effective mode-field diameter (MFD) between 14 microns and 40 microns;
wherein the optical fiber exhibits a higher-order mode loss of L_{HOM} and a higher-order mode power overlap of P_{HOM}.

14. The optical fiber of claim 13, wherein the fiber comprises a fundamental mode effective MFD between 14 microns and 37 microns.

15. The optical fiber of claim 13, further comprising a second cladding ring around the core.

16. The optical fiber of claim 13, wherein sides of the cladding ring acquire a slope during draw.

17. The optical fiber of claim 13, wherein L_{HOM} of the optical fiber is at least 1.5 times greater than an optical fiber having the set of core properties without the cladding ring.

18. The optical fiber of claim 13, wherein the P_{HOM} of the optical fiber is at least 30% less than an optical fiber having the set of core properties without the cladding ring.

19. The optical fiber of claim 13, wherein the set of core properties comprise:
a core having a delta n less than 2e-3.

20. The optical fiber of claim 13, wherein the ring comprises a delta n<0.7×delta n of the ring.

21. The optical fiber of claim 1, wherein the fiber comprises a fundamental mode loss less than 1 dB/m occurring at a bend diameter between 5 cm and 30 cm.

22. A method of increasing higher-order mode suppression in large mode area fibers, comprising:
providing an optical fiber comprising:
a core having a delta n less than 2e-3;
a cladding ring around the core, the cladding ring starting between 3 microns and 15 microns from the edge of the core;
wherein the optical fiber has fundamental mode effective mode-field diameter (MFD) between 14 microns and 40 microns;
wherein the optical fiber exhibits a higher-order mode loss of L_{HOM} and a higher-order mode power overlap of L_{HOM}; and
propagating light through the optical fiber.
